(19) United States
(12) Patent Application Publication
(10) Pub. No.: US 2016/0325422 A1
(43) Pub. Date: Nov. 10, 2016

(54) Hard Ground Breaker

(71) Applicant: Leland Stucker, Lawrenceburg, TN (US)

(72) Inventor: Leland Stucker, Lawrenceburg, TN (US)

(21) Appl. No.: 15/147,325

(22) Filed: May 5, 2016

Related U.S. Application Data
(60) Provisional application No. 62/157,366, filed on May 5, 2015.
(60) Provisional application No. 62/240,058, filed on Oct. 12, 2015.

(51) Int. Cl. B25D 7/00

(52) U.S. Cl. CPC B25D 7/00

(57) ABSTRACT

A ground breaking device comprises an elongated shaft having a length extending longitudinally from a proximal end to a distal end. The length is no greater than 7 feet and the distal end ends in a point. At least one stepping member extends out from the elongated shaft. The at least one stepping member has a longitudinal length along the shaft that is no more than 1/15 of the length of the shaft in the longitudinal direction. The at least one stepping member has a widened step of 1 to 5 inches and the shaft has a diameter between about 0.5″ and 2″.

### CROSS-REFERENCE TO RELATED APPLICATIONS

Applicant claims the benefit of provisional patent applications 62/240,058 and 62/157,336.

### STATEMENT REGARDING FEDERALLY SPONSORED RESEARCH

Not Applicable

### FIELD OF THE INVENTION

This invention relates to a tool for breaking up hard ground.

### BACKGROUND OF THE INVENTION

Digging holes or breaking ground in hard ground can be very difficult. There are expensive machines that can be purchased that allow for this. Oftentimes, however, a homeowner or landscape professional would prefer to carry and use a small tool rather than buying or renting expensive equipment. In some instances the work is in small spaces that would not allow for larger pieces of equipment. Shovels are often ineffectual in hard ground and picks require more effort and space while also being of greater concern for injury. A device that is effective in breaking up ground safely and effectively is a simple manner is desirable.

The instant invention, as disclosed within this application, fills this need. The art referred to and/or described within this application is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment of the invention the ground breaking device comprises an elongated shaft having a length extending longitudinally from a proximal end to a distal end with the length being no greater than 7 feet. The distal end has a point. At least one stepping member extends out from the elongated shaft and has a longitudinal length along the shaft that is no more than 1/15 of the length of the shaft in the longitudinal. The at least one stepping member can have a widened step of 1 to 5 inches, the shaft having a diameter between about 0.5″ and 2″.

In at least one embodiment of the invention the shaft extends distally from the position distal to the at least one stepping member and has a diameter similar both immediately proximal and immediately distal to the at least one stepping member.

In at least one embodiment of the invention the device can have two stepping members.

In at least one embodiment of the invention the ground breaking device can have a widened diameter at the proximal end such that the widened diameter can have a diameter at least one half an inch wider than the shaft. In some embodiment up to two or more inches.

In at least one embodiment of the invention the portion of the shaft distal to the at least one stepping member is about one foot in length.

In at least one embodiment of the invention the at least one stepping member can have a position on the shaft that is adjustable such that the at least one stepping member can be adjusted along the shaft such that the portion of the shaft distal to the at least one stepping member can be shortened and lengthened between 4 inches and three feet.

In at least one embodiment of the invention the shaft can be constructed of metal.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a schematic perspective view of an embodied ground breaking device having a shortened handle.

FIG. 2 is a front view of an embodied ground breaking device.

FIG. 3 is a top view of an embodied ground breaking device.

FIG. 4 is a partial side view of an embodied device.

FIG. 5 is a schematic perspective view of an embodied ground breaking device having a shortened handle.

FIG. 6 is a front view of an embodied ground breaking device.

FIG. 7 is a top view of an embodied ground breaking device.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

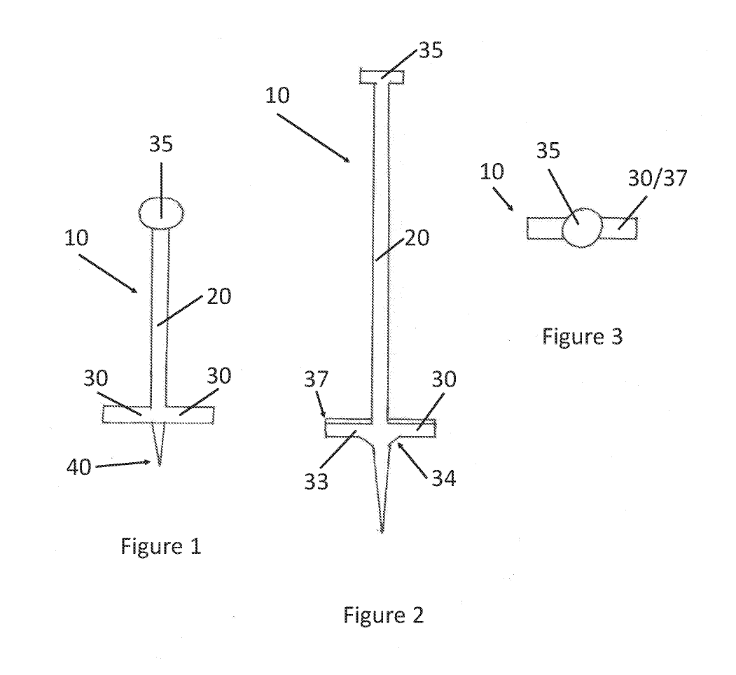

In FIG. 1, an inventive embodiment of the ground breaking device 10 is shown. The device as shown has a shaft 20 and stepping members 30. The shaft 20 has a proximal end with a widened head 35 and a pointed distal end 40. The shaft 20 can be of varying lengths; the shaft of the FIG. 1 embodiment is shorter than that of the embodiment of FIG. 2. The widened head is designed for use with a sledge hammer or other striking implement. This feature can help to break through rocks or concrete or the like. Though shown in the figures, the widened head 35 is not present in some embodiments.

Though two stepping members 30 are shown, in some embodiments only a single stepping member is present. Three or more stepping members are also considered. When the device is being used and is partially embedded in the ground being able to apply force from a different direction via multiple stepping members about the shaft can in some instances improve functionality. In some embodiments the stepping members can be folded up along the shaft when those stepping members are not being used or when being stored.

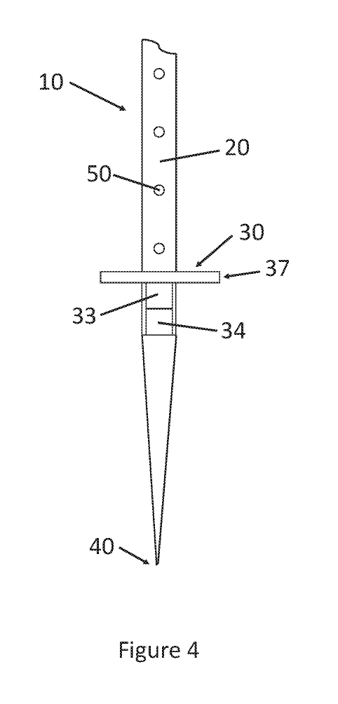

As shown in FIG. 2, the device 10 has a longer shaft 20 than that shown in FIG. 1. The shaft portion above the stepping member 30 has a length that is about 4 times greater than the length below the stepping member. In some embodiments this can bring the length of the device to around 5 feet. Thus, the length below the stepping member could be around 1 foot and the length above around 4 feet. Of course, in some embodiments the stepping member is positionally adjustable and the ratios could be much larger or much smaller. In some such embodiments, the stepping member(s) could be part of a collar positioned about the shaft with the collar having a pin fitting into holes 50 positioned along a longitudinal length of the shaft 20 (See FIG. 4). In some applications of using the device, the pointed portion 40 needs to reach a deeper edge of a piece of rock or other obstructing material. In those instances, being able to raise the stepping member 30 would allow the device 10 to reach a deeper depth.

Throughout this specification the longitudinal direction means the direction along the elongated shaft. The transverse direction is the direction substantially orthogonal to the longitudinal direction.

In some embodiments the stepping member support 33 can include angled portion 34. The support 33/34 can be narrower than the shaft 20 or substantially equal. In some embodiments, the more distal end of the angled portion 34 can have edges that fit into slots in order to stabilize and/or position a longitudinally adjustable stepping member 30.

The stepping member 30 can also include a widened step pad 35 as shown best in FIGS. 2 and 4. The step pad 37 can be better for the health of the foot and can allow for greater pressure to be applied consistently. The step pad 37 in most embodiments can be between 1 and 4 inches wide.

In FIG. 3 a top view is shown. The widened head 35 can be constructed for receiving the blows from a sledge hammer or other striking implement. The step pad 37 is also shown and gives an example of the dimensions that can be used in some embodiments.

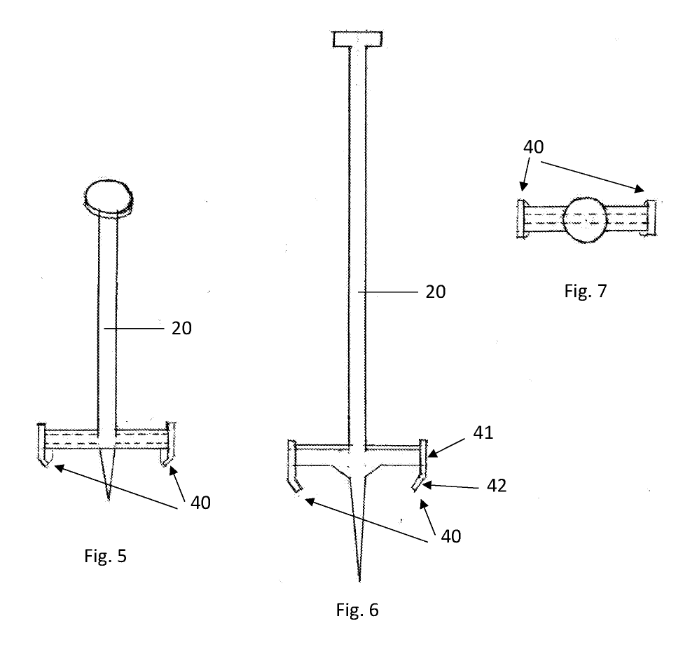

As shown in FIGS. 5-7, an additional wing portion 40 is included. The winged portion has an upper portion 41 that is substantially parallel to the shaft 20 and a lower angled portion 42 that is at an oblique angle to the shaft 20. The winged portion 40 can provide a fulcrum about which to help pry up rocks or other objects on the ground or within the soil. It can also be used as a means to lift logs from the ground in order to avoid a saw blade being dulled. It can be made shorter or longer for this and other purposes.

In some embodiments the device is at least composed in part of metal, polymer/plastic, and/or ceramic. The shaft 20 can be hollow in some embodiments. In some embodiments, the hollow portion can be less than the full length of the shaft. This can lessen the weight of the device. In some applications the greater strain when prying will be located in the lower half of the shaft length; thus, the hollow portion may be confined to the upper half or less of the shaft length.

In some embodiments the shaft can be of one piece construction. In some embodiments the shaft and/or widened head is constructed in part or entirely of hardened steel.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

The invention claimed is:

1. A ground breaking device comprising an elongated shaft having a length extending longitudinally from a proximal end to a distal end, the length being no greater than 7 feet, the distal end having a point, at least one stepping member extending out from the elongated shaft, the at least one stepping member having a longitudinal length along the shaft that is no more than 1/15 of the length of the shaft in the longitudinal direction, the at least one stepping member having a widened step of 1 to 5 inches, the shaft having a diameter between about 0.5″ and 2″.

2. The ground breaking device of claim 1 wherein the shaft extends distally from a position distal to the at least one stepping member and has a diameter similar both immediately proximal and immediately distal to the at least one stepping member.

3. The ground breaking device of claim 1 having two stepping members.

4. The ground breaking device of claim 1 having a widened diameter at the proximal end, the widened diameter having a diameter at least one half an inch wider than the shaft.

5. The ground breaking device of claim 1 wherein the portion of the shaft distal to the at least one stepping member is about one foot in length.

6. The ground breaking device of claim 1 wherein the at least one stepping member has a position on the shaft that is adjustable, the at least one stepping member being adjustable along the shaft such that the portion of the shaft distal to the at least one stepping member can be shortened and lengthened between 4 inches and three feet.

7. The ground breaking device of claim 1 wherein the shaft is constructed of metal.

8. A ground breaking device comprising an elongated shaft having a length extending longitudinally from a proximal end to a distal end, the distal end having a point, at least one stepping member extending out from the elongated shaft, the at least one stepping member having a winged portion, the winged portion having has an upper portion that is substantially parallel to the shaft and a lower angled portion that is at an oblique angle to the shaft.
